(19) United States
(12) Patent Application Publication
(10) Pub. No.: US 2011/0077995 A1
(43) Pub. Date: Mar. 31, 2011

(54) SYSTEM AND METHOD FOR COLLECTING AND PROPAGATING COMPUTER BENCHMARK DATA

(75) Inventor: Tristan G. RINEHART, San Francisco, CA (US)

(73) Assignee: CBS INTERACTIVE, New Castle, DE (US)

(21) Appl. No.: 12/566,810

(22) Filed: Sep. 25, 2009

(51) Int. Cl. G06Q 10/00; G06F 15/00; G06Q 30/00; G06Q 50/00

(52) U.S. Cl. 705/10; 702/186; 705/347; 705/27.1

(57) ABSTRACT

An improved system and method for collecting and propagating computer benchmark data is described. A user downloads from a server and runs client software on a particular computer system, configuration, or component. The client software performs benchmarking functions on the system, returns the results to the user, and uploads the data to the server, where it is saved to the appropriate product record. The compiled benchmark scores are displayed on a product page, can be used further used for various business purposes.

### BACKGROUND OF THE INVENTION

1. Field of the Invention

The present invention relates generally to performance measurement in an electronic data processing system. In particular, the present invention relates to calculating performance benchmarks for various computer system configurations to create and propagate product-specific data.

2. Description of Related Art

In computing, a benchmark is a set of operations run on a computer system to evaluate the relative performance of various components in a particular configuration. Generally, this is done by running a number of standards tests and trials against a component. Any component, or combination of components, can be benchmarked to assess its performance, including hardware components, such as CPUs and processors, and software components, such as office applications and gaming programs.

Conventional benchmarking systems are designed to mimic a particular workload on a component. For example, synthetic benchmarks use a specially-created program based on the actual workload of the system to measure the relative performance of a component compared to similar components in other configurations. Application benchmarks run real-world programs, such as word processing software, in order to accurately measure performance of the component under a given workload. Both types of benchmarking allow a user to judge the performance of a component and the computer configuration as a whole.

Benchmarking is known to be used for several different purposes. For example, as described in U.S. Patent Publication No. 2005/0216479 to Wefers et al., a computer operating system may use a benchmarking tool in order to see if a system's hardware meets software requirements. Alternatively, a computer developer may use benchmarks to measure its system's performance increase over a competitor's system. A user may also use benchmarking to identify particular components that may be slowing down the operation of the system as a whole.

### SUMMARY OF THE INVENTION

One exemplary embodiment includes a method and system whereby benchmark data for a computer system, configuration, or component is collected and propagated. A user downloads and runs the client software from a host server, which performs benchmark testing on the computer and calculates its scores. The benchmark data is then returned to the host server, where it is matched to the appropriate product record and displayed to the user. Advantageously, the product record and benchmark data is specific to the particular computer system, configuration, or component being benchmarked, adding useful, relevant data to the product record.

In another embodiment, the collected benchmark data may be further used for additional purposes. For instance, the benchmark data may be sold to third parties, cross-referenced with user demographic data for targeted sales, and/or used for sorting by system type. Additionally, upgrade options may be returned to the user based on the results of the benchmark testing, and/or identical configurations across manufacturers can be analyzed. Advantageously, these additional options provide for greater business intelligence and development in benchmarking.

Still other aspects, features and advantages of the present invention are readily apparent from the following detailed description, simply by illustrating a number of exemplary embodiments and implementations, including the best mode contemplated for carrying out the present invention. The present invention also is capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a flowchart illustrating the method according to one embodiment of the invention.

FIG. 2 is a flowchart illustrating the method according to another embodiment of the invention.

FIG. 3 is a schematic diagram of a system for collecting benchmark data according to one embodiment of the invention.

FIG. 4 is a block diagram of an architecture for collecting benchmark data according to one embodiment of the invention.

FIG. 5 is a detailed block diagram of an architecture for collecting and propagating benchmark data according to one embodiment of the invention.

FIG. 6 is a schematic diagram of an exemplary computer system according to one embodiment of the invention.

FIG. 7 is a screenshot of an exemplary user interface of a system for collecting benchmark data according to an embodiment of the invention.

### DETAILED DESCRIPTION

An improved system and method for collecting and propagating computer benchmark data is described. In the following description, for purposes of explanation, numerous specific details are set forth in order to provide a thorough understanding of the exemplary embodiments. It is apparent to one skilled in the art, however, that the present invention can be practiced without these specific details or with an equivalent arrangement. In some instances, well-known structures and devices are shown in block diagram form in order to avoid unnecessarily obscuring the preferred embodiment.

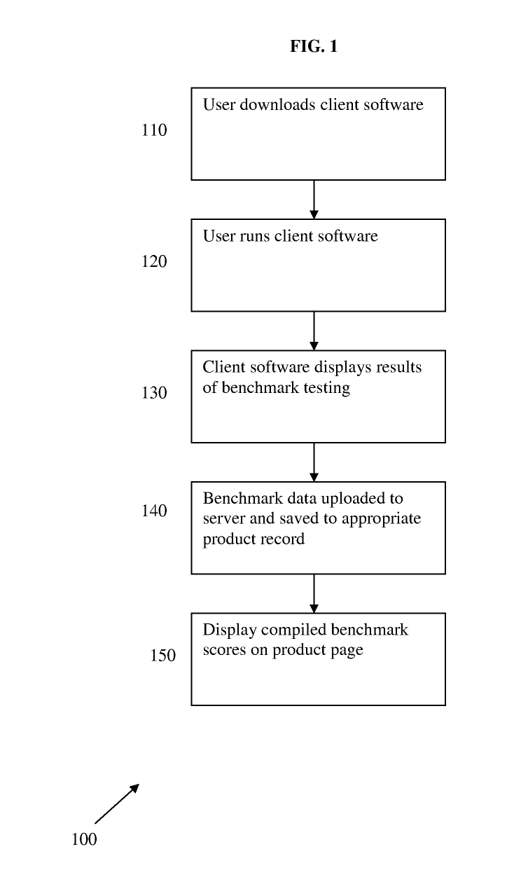

The invention facilitates correlating real world benchmark data with product records, such as product reviews and product catalog information. Referring now to the drawings, wherein like reference numerals designate identical or corresponding parts throughout the several views, FIG. 1 shows flowchart 100 illustrating the method according to one embodiment of the invention. A user downloads the client software 110 onto his or her computer, then runs the client software 120. The client software runs specifically designed benchmarking functions, including, for example, multimedia multitasking, image processing, and encoding, and calculates the computer's benchmarking scores in a known manner. The client software then displays the results of the benchmark testing to the user 130. At step 140, the benchmark data is uploaded to a server and saved in association with the appropriate product record. The product record may contain product specification information, in addition to the benchmark data. For example, the product record for a desktop computer may contain information on manufacturer, price, part number, operating system, processor, etc.

The benchmark data may be matched to the product record in a variety of ways. For example, any of the user, the component itself, and/or the client software may identify the product record to which the benchmark data is to be saved. At 150, the product record, including the compiled benchmark scores from multiple computers having the client software, are displayed on a product webpage for that particular configuration or component. In this manner, a database of product records and benchmark data is created by input from multiple users.

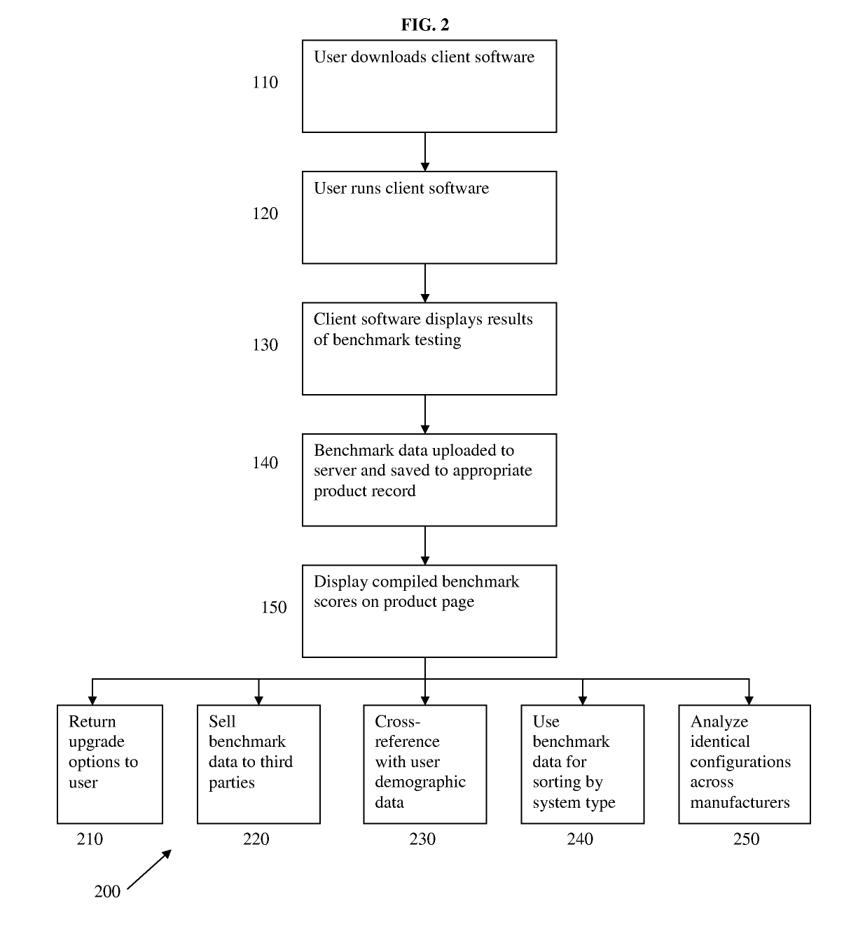

FIG. 2 shows flowchart 200 illustrating the method according to a second embodiment of the invention. After step 150, in which the product record is displayed on a product webpage for that particular configuration or component, any and/or all of steps 210-250 may be completed. At 210, upgrade options for the tested system are returned to the user. Upgrade options may be located, for example, by searching the product records for systems with improved benchmarking scores as compared to the benchmarking scores of the user's computer. At 220, the benchmark data may be sold to interested third parties, such as computer manufacturers studying the long-term performance of their systems.

At 230, the benchmark data may be cross-referenced with user demographic or user profile data, such as age, gender, income, location, browsing history, and/or interests. Based on the collected benchmark data and the user's demographics, targeted computer sales may be made to the user. For example, the client software may recommend a new inexpensive laptop available in multiple colors to a college-aged user whose benchmark data indicates that the current computer is failing in its basic functions. At 240, the benchmark data may additionally be used to sort by system type and product brief scenarios. At step 250, the benchmark data of identical configurations across multiple manufacturers may be analyzed in order to, for example, determine the most reliable manufacturer with the best performance for a given system.

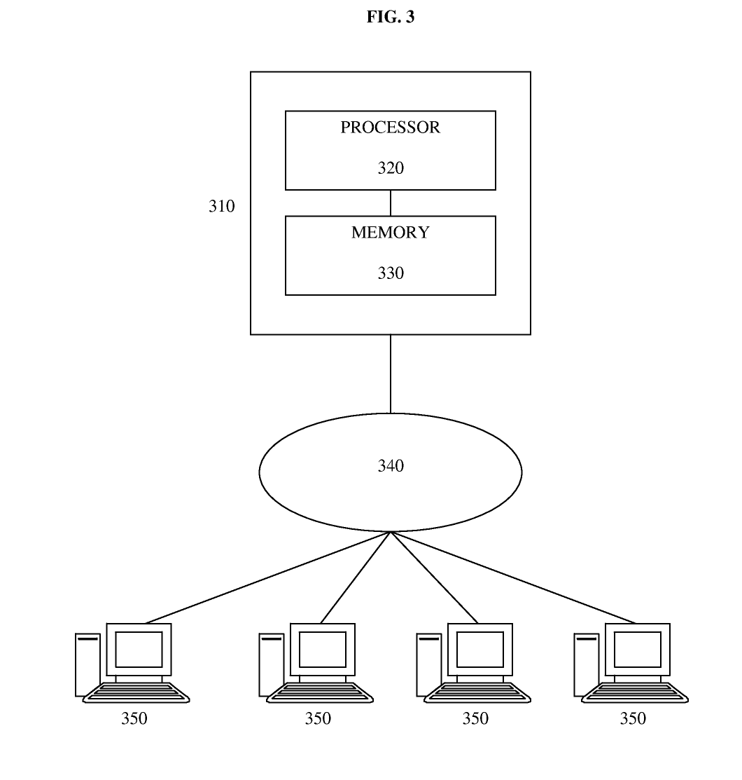

FIG. 3 illustrates server 310 that is connected over network 340 to a plurality of user systems 350. Server 310 includes processor 320 and memory 330, which are in communication with one another. Server 310 is configured to deliver the client software and online content to users at the plurality of user systems 350. Server 310 is typically a computer system, and may be an HTTP (Hypertext Transfer Protocol) server, such as an Apache server. Memory 330 may be any type of storage media that may be volatile or non-volatile memory that includes, for example, read-only memory (ROM), random access memory (RAM), magnetic disk storage media, optical storage media, flash memory devices, and zip drives. Network 340 may be a local area network (LAN), wide area network (WAN), a telephone network, such as the Public Switched Telephone Network (PSTN), an intranet, the Internet, or combinations thereof. The plurality of user systems 350 may be mainframes, minicomputers, personal computers, laptops, personal digital assistants (PDAs), cell phones, and the like. The plurality of user systems 350 are characterized in that they are capable of being connected to network 340. The plurality of user systems 350 typically include web browsers.

In use, when a user of one of the plurality of user systems 350 wants to, for example, download the client software or view the benchmarking results, a request to access content is communicated to server 310 over network 340. For example, a signal is transmitted from one of the user systems 350, the signal having a destination address (e.g., address representing the server), a request (e.g., content request), and a return address (e.g., address representing the user system that initiated the request). Processor 320 accesses memory 330 to provide the requested content, which is communicated to the user over network 340. For example, another signal may be transmitted that includes a destination address corresponding to the return address of the client system, and the content responsive to the request.

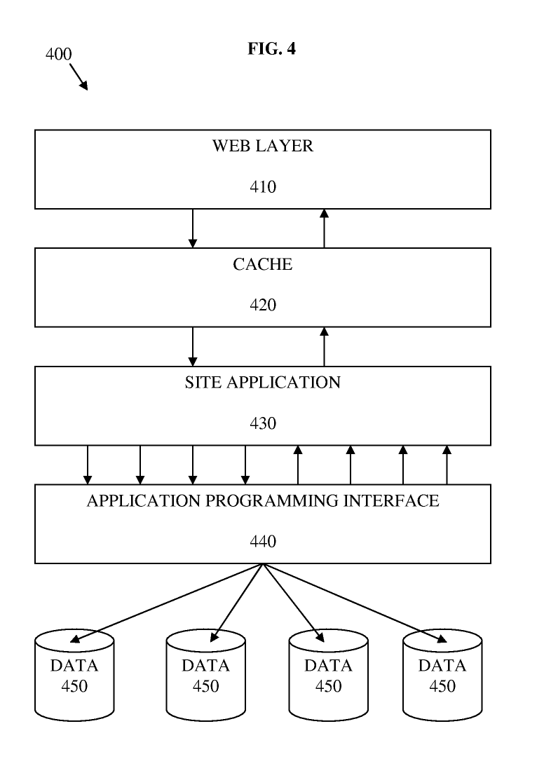

As shown in FIG. 4, system architecture 400 includes web layer 410, cache 420, site application 430, application programming interface 440, and a plurality of data stores 450. It will be appreciated that the system architecture may vary from the illustrated architecture. For example, web layer 410 may directly access data stores 450, the site application may directly access data stores 450, system architecture 400 may not include cache 420, etc., as will be appreciated by those skilled in the art. Web layer 410 is configured to receive user requests to access content through a web browser and return content that is responsive to the user request. Web layer 410 communicates the user requests to cache 420. Cache 420 is configured to temporarily store content that is accessed frequently by web layer 410 and can be rapidly accessed by web layer 410. In one embodiment, cache 420 may be a caching proxy server. Cache 420 communicates the user requests to site application 430.

Site application 430 is configured to update cache 420 and to process user requests received from web layer 419. Site application 430 may identify that the user request is for a page that includes data from multiple sources. Site application 430 can then convert the page request into a request for content from multiple sources and transmits these requests to application programming interface 440. Application programming interface 440 is configured to simultaneously access data from the plurality of data stores 450 to collect the data responsive to the plurality of requests from site application 430. The plurality of data stores 450 may include the client software, previously stored benchmark data, and catalogue data about different product types (e.g., product specifications, pricing, images, etc.). It will be appreciated that in alternative embodiments only one data store 450 may be provided to store the data.

The data in data stores 450 is provided to application programming interface 440, which provides the content to site application 430. Site application 430 updates cache 420 and delivers the cached content in combination with the accessed content to web layer 410, which delivers browsable content to the user, such as through a product page.

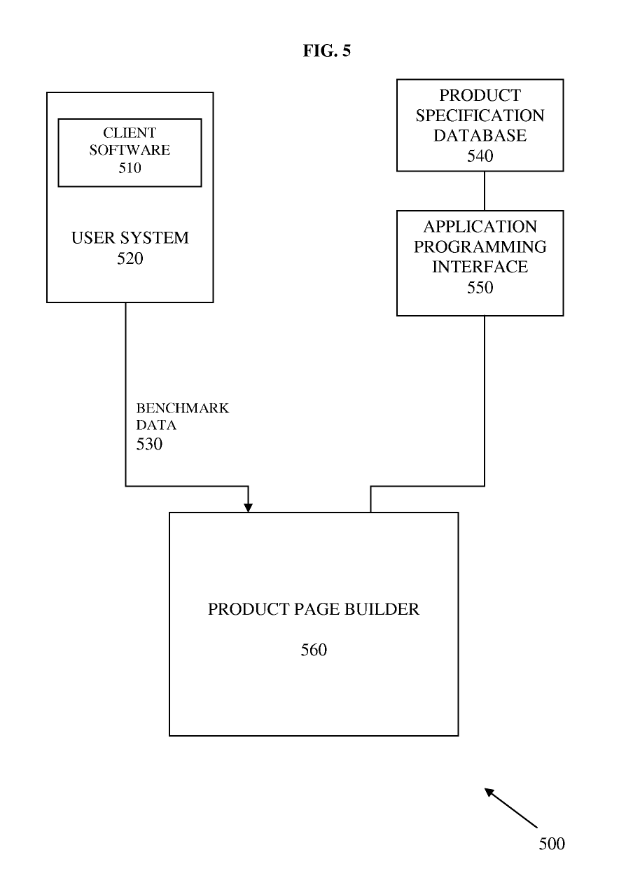

FIG. 5 illustrates a detailed system for collecting and propagating benchmark data 500 according to one embodiment of the invention. As shown in FIG. 5, system 500 includes client software 510 that is in communication with user system 520. It will be appreciated that user system 520 may be an entire configuration of components or a single component. Client software 510 runs specifically designed benchmarking functions on user system 520, including, for example, multimedia multitasking, image processing, or encoding, and calculates the system's benchmarking scores based on the results. Benchmark data 530 is uploaded from user system 520 to product page builder 560. Meanwhile, application programming interface 550 receives a request for product specifications in product specification database 540 corresponding to user system 520. Application programming interface 550 is used by product page builder 550 to interface with database 540 and fulfill the request for product specifications from database 540. Product page builder 560 matches benchmark data 530 to product specifications from database 540 by any of the methods previously described, and creates a product webpage displaying benchmark data and product specifications for user system 520.

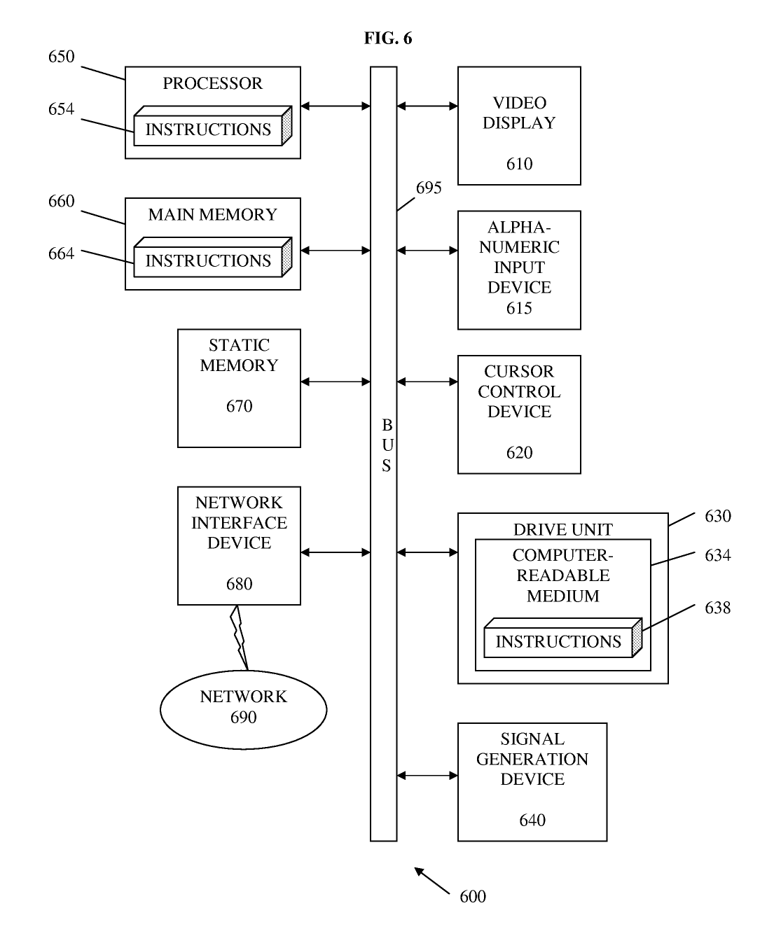

FIG. 6 shows a diagrammatic representation of machine in the exemplary form of computer system 600 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Exemplary computer system 600 includes processor 650 (e.g., a central processing unit (CPU), a graphics processing unit (GPU) or both), main memory 660 (e.g., read only memory (ROM), flash memory, dynamic random access memory (DRAM) such as synchronous DRAM (SDRAM) or Rambus DRAM (RDRAM), etc.) and static memory 670 (e.g., flash memory, static random access memory (SRAM), etc.), which communicate with each other via bus 695.

Computer system 600 may further include video display unit 610 (e.g., a liquid crystal display (LCD) or a cathode ray tube (CRT)). Computer system 600 also includes alphanumeric input device 615 (e.g., a keyboard), cursor control device 620 (e.g., a mouse), disk drive unit 630, signal generation device 640 (e.g., a speaker), and network interface device 680.

Disk drive unit 630 includes computer-readable medium 634 on which is stored one or more sets of instructions (e.g., software 638) embodying any one or more of the methodologies or functions described herein. Software 638 may also reside, completely or at least partially, within main memory 660 and/or within processor 650 during execution thereof by computer system 600, main memory 660 and processor 650 also constituting computer-readable media. Software 638 may further be transmitted or received over network 690 via network interface device 680.

While computer-readable medium 634 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding or carrying a set of instructions for execution by the machine and that cause the machine to perform any one or more of the methodologies of the present invention. The term “computer-readable medium” shall accordingly be taken to include, but not be limited to, solid-state memories, and optical and magnetic media.

It should be noted that the embodiments are illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a computer-readable medium as above as modules in any manner, and can be used separately or in combination.

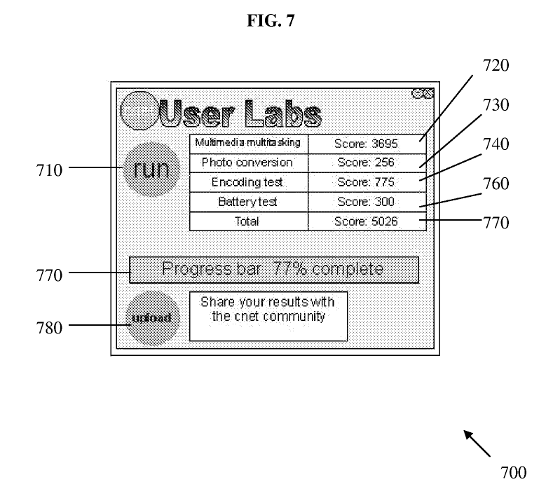

FIG. 7 illustrates a screenshot of user interface 700 for the client software. A user selects to run the client software with run button 710. Various benchmarking functions 720-750 are run and results calculated for each function. Total score 760 is a sum of the results from various benchmarking functions 720-750 and may be used as a comparison score against similar systems or components, as discussed above. Progress bar 770 indicates the percentage of total progress made on the benchmark testing. When progress bar 770 indicates 100% completion and benchmarking functions 720-750 are complete, the user may select upload button 780 to upload the results to the server, as discussed above.

It should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention.

Moreover, other implementations of the invention will be apparent to those skilled in the art from consideration of the specification and practice of the invention disclosed herein. Various aspects and/or components of the described embodiments may be used singly or in any combination. It is intended that the specification and examples be considered as exemplary only, with a true scope and spirit of the invention being indicated by the following claims.

What is claimed is:

1. A computer-implemented method for processing benchmark data, the method comprising:
providing an application that is configured to calculate performance benchmarks of a computer system;
receiving results of the performance benchmarks of the computer system, at a server, from the application;
propagating, at the server, the results of the performance benchmarks of the computer system to a product record associated with the computer system; and
displaying the product record with the propagated results.

2. The method of claim 1, wherein the performance benchmarks are based on one or more selected from the group consisting of multimedia multitasking, image processing, and encoding functions.

3. The method of claim 1, wherein the results of the performance benchmarks are indicative of the performance of the computer system for a particular function.

4. The method of claim 1, wherein the product record contains specification data about the computer system.

5. The method of claim 4, wherein the specification data is at least one of manufacturer, price, and part number.

6. The method of claim 1, further comprising:
analyzing the performance benchmarks to determine value assessments; and
comparing the value assessments with user profile data.

7. The method of claim 6, wherein the user profile data comprises one or more selected from the group consisting of age, gender, income, location, history, and interests.

8. The method of claim 1, further comprising:
identifying upgrade options for the computer system using the results of the performance benchmarks; and
displaying the upgrade options to a user.

9. The method of claim 1, wherein displaying the product record with the propagated results further comprises displaying the product record with an average of all propagated results of performance benchmarks for the computer system from a plurality of users.

10. The method of claim 1, further comprising one or more selected from the group consisting of:
selling the results of the performance benchmarks to third parties;
cross-referencing the results of the performance benchmarks with user demographic data;
using the results of the performance benchmarks for sorting by system type; and
analyzing the results of the performance benchmarks of the computer system against similar configurations across one or more manufacturers.

11. A computer system for processing benchmark data, the computer system comprising:
a data store configured to store a plurality of results of performance benchmarks;
a processor coupled to the data store and programmed to receive results of the performance benchmarks, propagate the results of the performance benchmarks to a product record, and display the product record with the propagated results to a user, wherein the product record is associated with a particular product.

12. The system of claim 11, wherein the product record is stored and accessed by the processor in a product specification database.

13. The system of claim 12, further comprising:
an application programming interface coupled to the product specification database and configured to receive and fulfill requests for product records stored in the product specification database corresponding to the computer system.

14. The system of claim 13, wherein the processor comprises a product page builder coupled to the application programming interface, the product page builder propagating the results of the performance benchmarks to the product record and displays the product record.

15. The system of claim 11, wherein the processor is further configured to analyze the performance benchmarks to determine value assessments, and compare the value assessments with user profile data.

16. A computer readable storage media having computer executable instructions stored thereon which case a computer system to carry out a method when executed, the method comprising:
providing an application that is configured to calculate performance benchmarks of a computer system;
receiving results of the performance benchmarks of the computer system, at a server, from the application;
propagating, at the server, the results of the performance benchmarks of the computer system to a product record associated with the computer system; and
displaying the product record with the propagated results.

17. The computer readable storage media of claim 16, wherein the results of the performance benchmarks are indicative of the performance of the computer system for a particular function.

18. The computer readable storage media of claim 16, wherein the product record contains specification data about the computer system.

19. The computer readable storage media of claim 16, wherein the method further comprises:
identifying upgrade options for the computer system using the results of the performance benchmarks; and
displaying upgrade options to a user.

20. The computer readable storage media of claim 16, wherein displaying the product record with the propagated results further comprises displaying the product record with an average of all propagated results of performance benchmarks for the computer system from a plurality of users.
